(19) United States
(12) Patent Application Publication
(10) Pub. No.: US 2003/0227653 A1
(43) Pub. Date: Dec. 11, 2003

(54) Self-diagnosis method for facsimile device and facsimile device to perform the same

(75) Inventor: Jin-Wook Jeong, Gyeonggi-do (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-city, Republic of Korea

(21) Appl. No.: 10/445,908

(22) Filed: May 28, 2003

(30) Foreign Application Priority Data
Jun. 7, 2002 (KR) 2002-31991

(51) Int. Cl. H04N 1/00; H04N 1/32

(52) U.S. Cl. 358/437; 358/436; 358/400

(57) ABSTRACT

A self-diagnosis method for a facsimile device and a facsimile device to perform the same. The facsimile device has a modem and a line interface unit (LIU) that connects the modem to an external line. The method includes determining whether a communication path is in a normal state or in an abnormal state according to the detection of a dial tone transmitted from an outside, and/or determining whether the modem is in a normal state or in an abnormal state according to whether a diagnosing tone signal generated in the facsimile device is normally received. Accordingly, the self-diagnosis method self-diagnoses errors in the peripheral environment of the facsimile device without communicating with another facsimile device. These errors may be errors on external lines, or errors in the facsimile device, e.g., errors in a modem.

### CROSS-REFERENCE TO RELATED APPLICATIONS

This application claims the priority of Korean Patent Application No. 2002-31991, filed Jun. 7, 2002 in the Korean Intellectual Property Office, the disclosure of which is incorporated herein by reference.

### BACKGROUND OF THE INVENTION

1. Field of the Invention

The present invention relates to a facsimile device, and more particularly, to a method of self-diagnosing a facsimile device, and a facsimile device to perform the same.

2. Description of the Related Art

In general, errors occurring during the process of sending or receiving a facsimile include errors in communication lines to connect the facsimile devices, and errors in the facsimile devices themselves. When one of these two types of errors occurs, a conventional method of diagnosing the facsimile device involves communicating with another device or using a separate external measuring instrument. Accordingly, if an error occurs when the receiving facsimile device or the separate external measuring instrument is absent, a user cannot promptly determine whether the error is occurring in the communication lines or in the user's facsimile device. Thus, repair of a facsimile device cannot be provided in real time.

### SUMMARY OF THE INVENTION

Accordingly, it is an aspect of the present invention to provide a self-diagnosis method for a facsimile device to self-diagnose errors in the peripheral environment of the facsimile device and/or errors in the facsimile device itself without communicating with the receiving device or without using an external measuring instrument.

It is another aspect of the present invention to provide a facsimile device to perform the self-diagnosis method.

Additional aspects and advantages of the invention will be set forth in part in the description which follows and, in part, will be obvious from the description, or may be learned by practice of the invention.

Accordingly, according to an aspect of the present invention, there is provided a self-diagnosis method for a facsimile device having a modem and a line interface unit (LIU) that connects the modem to an external line, the method including determining whether a communication path is in a normal state or in an abnormal state according to a detection of a dial tone transmitted from an outside, and determining whether the modem is in a normal state or in an abnormal state according to whether a diagnosing tone signal generated in the facsimile device is normally received.

According to another aspect of the present invention, there is provided a facsimile device to perform self-diagnosis using an LIU to connect a modem and an external line, the facsimile device including the modem, a dial tone detection unit to detect a dial tone and output a detection result, and a first error determination unit to determine whether the communication path is in a normal state or in an abnormal state in response to the detection result.

In addition, according to another aspect of the present invention, there is provided a facsimile device to perform self-diagnosis using an LIU to connect a modem and an external line and the modem, the facsimile device including a tone signal generation unit to generate and transmit a diagnosing tone signal, a tone signal receiving unit to receive the tone signal generated from the tone signal generation unit, and a second error determination unit to determine whether the modem is in a normal state or in an abnormal state from the received tone signal and the transmitted tone signal.

### BRIEF DESCRIPTION OF THE DRAWINGS

These and/or other aspects and advantages of the present invention will become apparent and more readily appreciated from the following description of the preferred embodiments, taken in conjunction with the accompanying drawings of which:

FIG. 1 is a flowchart for explaining a self-diagnosis method for a facsimile device according to an embodiment of the present invention;

FIG. 2 is a flowchart for explaining operation 10 of FIG. 1;

FIG. 3 is a flowchart for explaining operation 12 of FIG. 1;

FIG. 4 is a block diagram of a portion of a facsimile device to perform the self-diagnosis method according to an embodiment of the present invention;

FIG. 5 is a block diagram of the second error determination unit of FIG. 4; and

FIG. 6 is a block diagram of features of the facsimile device of FIG. 4.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to like elements throughout.

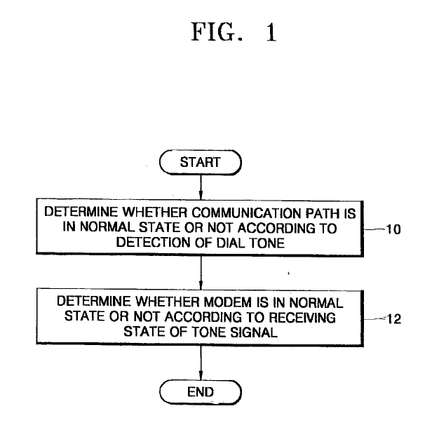

FIG. 1 is a flowchart for explaining a self-diagnosis method for a facsimile device according to an embodiment of the present invention. Referring to FIG. 1, the method includes operations 10 and 12 to determine whether communication lines and/or a modem is in a normal state or in an abnormal state.

The method of FIG. 1 is performed in a facsimile device (not shown) having a modem (not shown) and a line interface unit (LIU) (not shown). Here, the LIU connects the modem to an outside line.

First, it is determined by detecting a dial tone supplied from the outside whether a communication path is in a normal state or in an abnormal state (operation 10). Here, the dial tone is generated in an exchange (network) (not shown) at the outside of the facsimile device and the communication path includes a line from the exchange to the facsimile device, the connection between the line and the facsimile device, and lines existing in the LIU. When the dial tone generated in the exchange is not detected, the communication path is determined as being abnormal. When the dial tone generated in the exchange is detected, the communication path is determined as being normal.

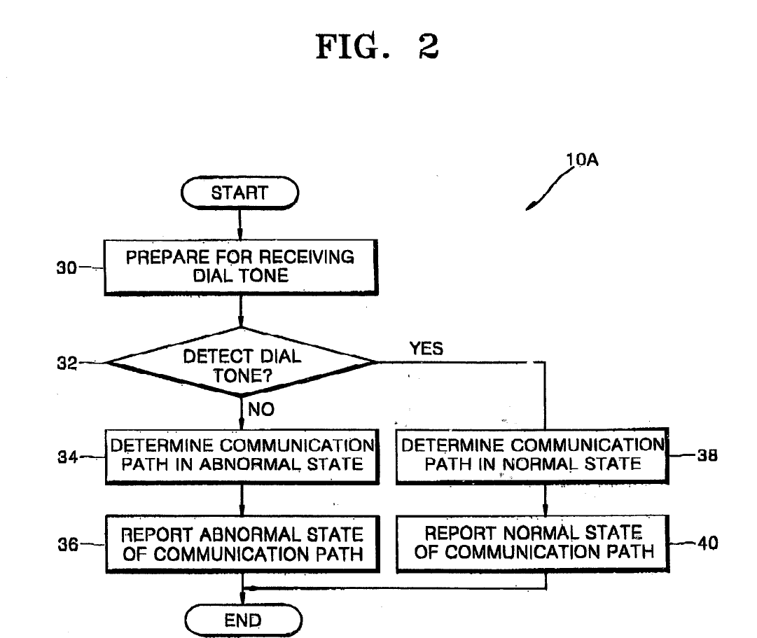

FIG. 2 is a flowchart for explaining operation 10 of FIG. 1.

Referring to FIG. 2, detection of the dial tone generated in the exchange is prepared (operation 30). In general, a facsimile device has a relay (not shown) that selectively connects the external exchange to a modem or a telephone (not shown) in the facsimile device. Here, in operation 30, the relay connects the external exchange to the modem in the facsimile device to prepare for the detection of the dial tone.

After operation 30, the facsimile device determines whether the dial tone generated in the exchange is detected or not (operation 32). If the dial tone is not detected, a communication path is determined as being abnormal (operation 34). In other words, if the dial tone is not detected, a line between the exchange and the facsimile device, the connection between the line and the facsimile device, or lines existing in the LIU are determined to be abnormal.

After operation 34, the facsimile device reports the abnormal state of the communication path in operation 36. For example, after operation 34, the facsimile device displays the message “check line” on a liquid crystal display (LCD) panel (not shown) in order to visually report the abnormal state of the communication path. Thus, the abnormal state of a line to transmit signals when communicating with another device is reported to the outside. As a result, if a user receives a report that the communication path is in the abnormal state, the user checks the communication path, namely, the line between the exchange and the facsimile device, the connection between the line and the facsimile device, and the lines in the LIU.

However, if the dial tone is detected, it is determined that the communication path is in a normal state in operation 38. After operation 38, the facsimile device reports that the communication path is in the normal state in operation 40.

Here, operation 10 of FIG. 2 may not include either one of operation 36 and operation 40.

Referring back to FIG. 1, after operation 10, the facsimile device determines whether the modem is in a normal state or in an abnormal state by determining whether a diagnosing tone signal generated in the facsimile device is received normally or not (operation 12). Here, the tone signal can be a single tone signal at a level of 1100 Hz or 2100 Hz, or a multi-tone signal. For example, the facsimile device feeds back the tone signal generated in the modem to the facsimile device in order to diagnose the state of the modem by using the level and/or frequency of the fed back tone signal.

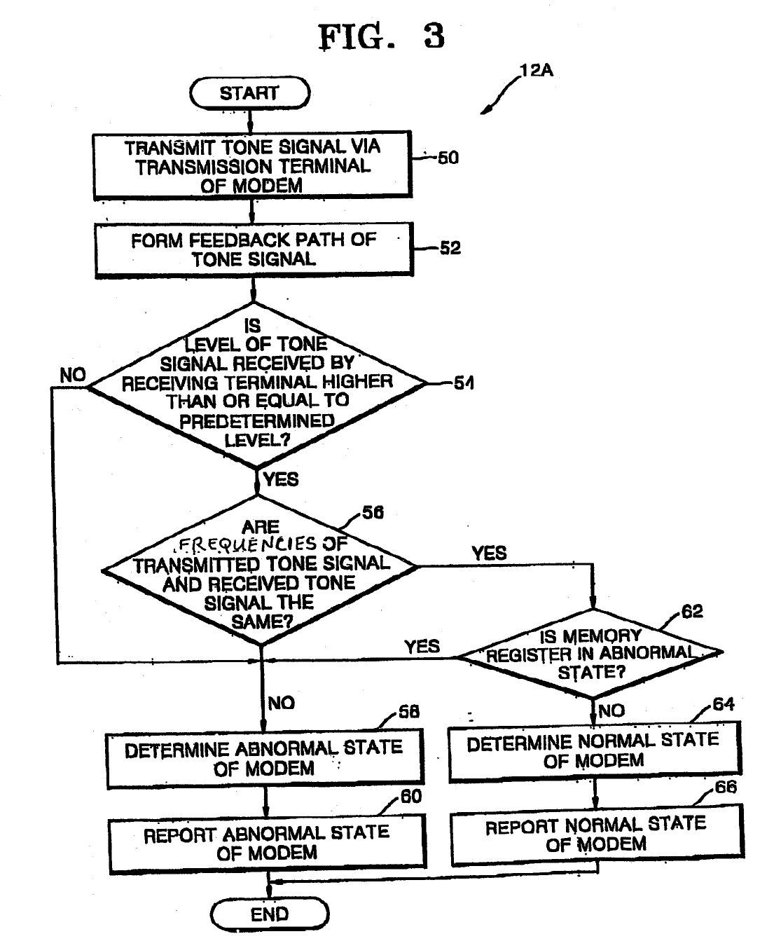

FIG. 3 is a flowchart for explaining operation 12 of FIG. 1.

Referring to FIG. 3, a tone signal is transmitted via a transmission terminal (not shown) of the modem in operation 50. After operation 50, a feedback path is formed in order to feed back the transmitted tone signal to a receiving terminal (not shown) of the modem, in operation 52.

Here, operation 12 of FIG. 3 may include at least one among operation 54, operation 56, and operation 62. In this case, operations 54, 56, and 62 are performed either in the order shown in FIG. 3, or another order.

When operation 12 of FIG. 3 includes operations 54, 56, and 62 (a first embodiment), after operation 52, it is determined whether the level of the tone signal received by the receiving terminal of the modem is over a predetermined level, in operation 54. Here, the predetermined level of the tone signal can be, for example, −43 dBm. If the level of the tone signal received by the receiving terminal of the modem is greater than or equal to the predetermined level, it is determined whether the frequency of the received tone signal is the same as the frequency of the transmitted tone signal, in operation 56. If the frequencies of the transmitted tone signal and the received tone signal are the same, the state of an interface memory register (not shown) embedded in the modem is checked in operation 62. Here, the setting of the interface memory register indicates the control of the modem by establishing a predetermined option but does not indicate a data buffering. In other words, the state of the interface memory can be determined by writing a specific value on a specific register in the interface memory and reading the value from the specific register.

Here, if the state of the memory register is determined as being abnormal, the frequencies of the transmitted tone signal and the received tone signal are different, or the level of the tone signal received by the receiving terminal is lower than the predetermined level, the facsimile device determines that the modem is in an abnormal state in operation 58. More specifically, if the level of the received tone signal is lower than the predetermined level, the modem cannot recognize the tone signal so that the modem is determined as being abnormal.

After operation 58, the abnormal state of the modem is reported in operation 60. For example, after operation 58, the facsimile device displays the message “check modem” on an LCD panel (not shown) in order to visually report the abnormal state of the modem. Accordingly, the abnormal state of the facsimile device is reported to the outside. Thus, the user noticing the report of the abnormal state of the modem can check the inside of the modem.

On the other hand, if the state of the memory register is determined as being normal, it is determined that the modem is in a normal state in operation 64. After operation 64, the facsimile device reports that the modem is in the normal state in operation 66.

In this case, operation 56 may be performed prior to operation 54, or operation 62 may be performed prior to operation 56 and/or operation 54.

Alternatively, operation 12 of FIG. 3 may not include operations 54 and 62 (a second embodiment). In this case, after operation 52, it is determined whether the frequency of the received tone signal is the same as the frequency of the transmitted tone signal, in operation 56. If the frequencies of the transmitted tone signal and the received tone signal are the same, the modem is determined as being in the normal state in operation 64. If the frequency of the transmitted tone signal and the frequency of the received tone signal are different, the modem is determined as being in the abnormal state in operation 58.

Alternatively, operation 12 of FIG. 3 may not include operation 62 (a third embodiment). In this case, if the frequency of the transmitted tone signal and the frequency of the received tone signal are different or the level of the received tone signal is lower than the predetermined level, the modem is determined as being in the abnormal state in operation 58. And, if the frequencies of the transmitted tone signal and the received tone signal are the same, the modem is determined as being in the normal state in operation 64. Here, operation 56 may be performed prior to operation 54. In other words, after operation 52, it is determined whether the frequency of the received tone signal is the same as the frequency of the transmitted tone signal, in operation 56. When it determined that the frequencies of the received tone signal and the transmitted tone signal are the same, it is determined whether the level of the tone signal received by the receiving terminal of the modem is over a predetermined level, in operation 54. If the level of the tone signal received by the receiving terminal of the modem is over the predetermined level, the modem is determined as being in the normal state in operation 64.

Alternatively, operation 12 of FIG. 3 may not include operations 56 and 62 (a fourth embodiment). If the level of the tone signal received by the receiving terminal of the modem is over a predetermined level, the modem is determined as being in the normal state in operation 64. However, if the level of the tone signal received by the receiving terminal of the modem is lower than a predetermined level, the modem is determined as being in the abnormal state in operation 58.

Alternatively, operation 12 of FIG. 3 may not include operation 54 (a fifth embodiment). After operation 52, it is determined whether the frequency of the received tone signal is the same as the frequency of the transmitted tone signal, in operation 56. Here, operation 62 may be performed prior to operation 56. Namely, after operation 52, the state of the memory register embedded in the modem is checked in operation 62. If the state of the memory register is determined as being normal, it is determined whether the frequency of the received tone signal is the same as the frequency of the transmitted tone signal, in operation 56. If the frequencies of the transmitted tone signal and the received tone signal are the same, the modem is determined as being in the normal state in operation 64.

Alternatively, operation 12 of FIG. 3 may not include operation 56 (a sixth embodiment). In this case, when it is determined that the level of the tone signal received by the receiving terminal of the modem is over a predetermined level, the state of the memory register embedded in the modem is checked in operation 62. Here, operation 62 may be performed prior to operation 54. Namely, after operation 52, the state of the memory register embedded in the modem is checked in operation 62. If the state of the memory register is determined as being normal, it is determined whether the level of the tone signal received by the receiving terminal of the modem is over a predetermined level, in operation 54. If the level of the tone signal received by the receiving terminal of the modem is over the predetermined level, the modem is determined as being in the normal state in operation 64.

Alternatively, operation 12 of FIG. 3 may not include operations 54 and 56 (a seventh embodiment). In this case, after operation 52, the state of the memory register embedded in the modem is checked in operation 62. If the state of the memory register is determined as being normal, the modem is determined as being in the normal state in operation 64. However, if the state of the memory register is determined as being abnormal, the modem is determined as being in the abnormal state in operation 58.

Alternatively, operation 12 of FIG. 3 may not include either one of operation 60 and operation 66.

The present self-diagnosis method may include only operation 10 or operation 12. Alternately, the method may include both operations 10 and 12, performed either in the order shown in FIG. 1, the opposite order, or at the same time.

The configuration and operation of a facsimile device according to the present invention will now be described with reference to accompanying drawings.

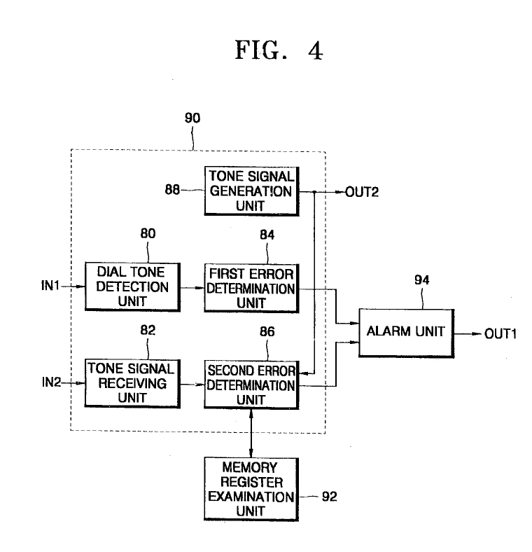

Referring to FIG. 4, the facsimile device is formed of a modem 90 having a dial tone detection unit 80, a tone signal receiving unit 82, first and second error determination units 84 and 86, a tone signal generation unit 88, a memory register examination unit 92, and an alarm unit 94.

The dial tone detection unit 80 examines if a dial tone generated in an exchange is input through an input terminal IN1 to perform operation 32. Thereafter, the dial tone detection unit 80 outputs the examination result to the first error determination unit 84. The first error determination unit 84, to perform operation 34 or operation 38, determines the state of the communication path in response to the examination result from the dial tone detection unit 80, and outputs the determination result to the alarm unit 94. For example, when the first error determination unit 84 recognizes the detection of the dial tone according to the detection result of the dial tone detection unit 80, the first error determination unit 84 determines that the communication path is in a normal state to perform operation 38. However, when the first error determination unit 84 recognizes that the dial tone is absent, the first error determination unit 84 determines that the communication path is in an abnormal state to perform operation 34.

Here, the alarm unit 94, which performs operations 36 and 40, reports the state of the communication path to the outside via an output terminal OUT1 in response to the determination result of the first error determination unit 84. For example, when the first error determination unit 84 determines that the communication path is in an abnormal state, the alarm unit 94 reports the abnormal state of the communication path via the output terminal OUT1 to perform operation 36. When the first error determination unit 84 determines that the communication path is in a normal state, the alarm unit 94 reports the normal state of the communication path via the output terminal OUT1 to perform operation 40.

The tone signal generation unit 88 generates a diagnosing tone signal and outputs the tone signal via an output terminal OUT2 in order to perform operation 50. Here, in order for the tone signal receiving unit 82 to receive the tone signal transmitted from the tone signal generation unit 88, (to perform operation 52), a feedback path is formed between the tone signal generation unit 88 and the tone signal receiving unit 82.

The tone signal receiving unit 82 and the second error determination unit 86 perform at least one of operations 54, 56, and 58. Here, the tone signal receiving unit 82 receives the tone signal generated in the tone signal generation unit 88 and is fed back to the tone signal receiving unit 82 via an input terminal IN2, and outputs the received tone signal to the second error determination unit 86. Here, the second error determination unit 86 determines the state of the modem according to the received tone signal input from the tone signal receiving unit 82 and the transmitted tone signal input from the tone signal generation unit 88, and outputs the determination result to the alarm unit 94.

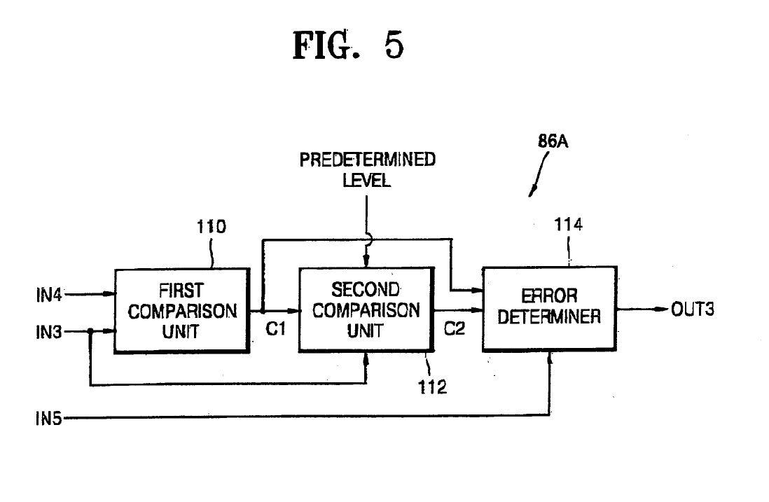

FIG. 5 is a block diagram of the second error determination unit 86 of FIG. 4. Referring to FIG. 5, the second error determination unit 86 is formed of a first comparison unit 110, a second comparison unit 112, and an error determiner 114.

The second error determination unit 86 of FIG. 5 performs the first and the third embodiments. For example, the first comparison unit 110 compares the frequency of the received tone signal, which is input through an input terminal IN3, with the frequency of the transmitted tone signal, which is input from the tone signal generation unit 88 via an input terminal IN4, and outputs the comparison result to the second comparison unit 112 as a first control signal C1, in order to perform operation 56.

In order to perform operation 54, the second comparison unit 112 compares the level of the received tone signal input via the input terminal IN3 with a predetermined level, in response to the first control signal C1, which is input from the first comparison unit 110. Thereafter, the second comparison unit 112 outputs the comparison result to the error determiner 114 as a second control signal C2. For example, when the frequency of the received tone signal is recognized as being equal to the frequency of the transmitted tone signal through the first control signal C1, the second comparison unit 112 compares the level of the received tone signal with the predetermined level.

In order to perform operations 58 and 64, the error determiner 114 determines the state of the modem in response to the first or second control signal C1 or C2, which is input from the first or second comparison unit 110 or 112, respectively, and outputs the determination result via an output terminal OUT3. For example, when the frequency of the received tone signal and the frequency of the transmitted tone signal are recognized as being different through the first control signal C1 input from the first comparison unit 110, the error determiner 114 determines that the modem is in the abnormal state. Or, when the level of the received tone signal is recognized as being under the predetermined level through the second control signal C2 input from the second comparison unit 112, the error determiner 114 determines that the modem is in the abnormal state. Thereafter, the error determiner 114 outputs the result of the determination via the output terminal OUT3.

In order to perform the second or the fifth embodiment, the second error determination unit 86 of FIG. 5 may include only the first comparison unit 110 and the error determiner 114. In this case, when the frequency of the received tone signal and the frequency of the transmitted tone signal are recognized as being different through the first control signal C1 input from the first comparison unit 110, the error determiner 114 determines that the modem is in the abnormal state.

In order to perform the fourth or the sixth embodiment, the second error determination unit 86 of FIG. 5 may include only the second comparison unit 112 and the error determiner 114. In this case, when the level of the received tone signal is recognized as being under the predetermined level through the second control signal C2 input from the second comparison unit 112, the error determiner 114 determines that the modem is in the abnormal state. In addition, the error determiner 114 outputs the result of the determination via the output terminal OUT3.

Referring back to FIG. 4, in order to perform operations 60 and 66, the alarm unit 94 reports the state of the modem via the output terminal OUT1 in response to the determination result of the second error determination unit 86. For example, if the second error determination unit 86 determines the modem to be in the abnormal state, the alarm unit 94 reports the abnormal state of the modem via the output terminal OUT1 in order to perform operation 60. If the second error determination unit 86 determines the modem to be in the normal state, the alarm unit 94 reports the normal state of the modem via the output terminal OUT1 in order to perform operation 66.

In order to perform operation 62, the memory register examination unit 92 checks the state of the memory register and outputs the check result to the second error determination unit 86.

In the first or the fifth embodiment, the memory register examination unit 92 checks the state of the memory register, in response to the first control signal C1 input from the first comparison unit 110 of FIG. 5. For example, if the frequency of the transmitted tone signal and the frequency of the received tone signal are recognized as being the same, through the first control signal C1 input from the first comparison unit 110, the memory register examination unit 92 examines whether the memory register is in a normal state or in an abnormal state.

In the sixth embodiment, the memory register examination unit 92 checks the state of the memory register, in response to the second control signal C2 input from the second comparison unit 112 of FIG. 5. For example, if the level of the received tone signal is greater than the predetermined level, through the second control signal C2 input from the second comparison unit 112, the memory register examination unit 92 examines whether the memory register is in a normal state or in an abnormal state.

In this case, the error determiner 114 of the second error determination unit 86 determines the state of the modem in response to the examination result of the memory register examination unit 92, and outputs the determination result via the output terminal OUT3. For example, if the memory register is recognized as being in an abnormal state according to the examination result of the memory register examination unit 92, the error determiner 114 determines that the modem is in an abnormal state and outputs the determination result via the output terminal OUT3.

As shown in FIG. 4, the modem 90 does not include the memory register examination unit 92 and the alarm unit 94. However, either or both of these elements may also be included in the modem 90.

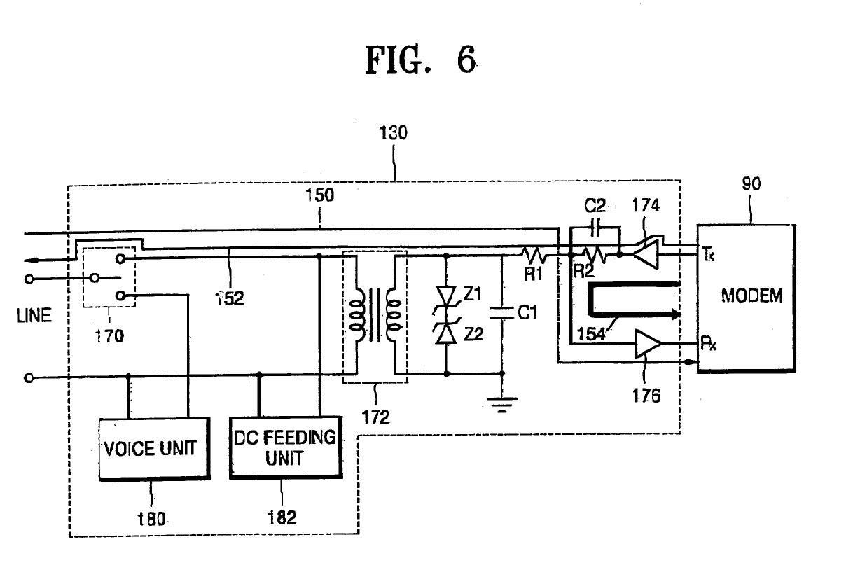

FIG. 6 is a block diagram of additional features of the facsimile device according to the present invention. Referring to FIG. 6, the facsimile device includes a line interface unit (LIU) 130 and the modem 90.

The LIU 130 of FIG. 6 is formed of a relay 170, a transformer 172, zenor diodes Z1 and Z2, capacitors C1 and C2, resistors R1 and R2, first and second amplifiers 174 and 176, a voice unit 180, and a direct current (DC) feeding unit 182.

Here, the voice unit 180 corresponds to a telephone, and the DC feeding unit 182 informs an exchange whether the facsimile device uses lines or not. In other words, the DC feeding unit 182 controls the current of the facsimile device according to whether the lines are connected, so that the exchange may recognize the state of use of the lines. Here, the relay 170 connects the line and the modem 90 or the line and the voice unit 180. The transformer 172 transmits signals between the external exchange and the modem 90.

The zenor diodes Z1 and Z2 protect the facsimile device from voltage overload, and the resistors R1 and R2 and the capacitors C1 and C2 are used for matching impedance. Here, the first amplifier 174 (or a first filter) is connected to the modem 90 to amplify or filter a signal output from a transmission terminal Tx of the modem 90. The second amplifier 176 (or a second filter) outputs the amplified or filtered result to a receiving terminal Rx of the modem 90.

In order to perform operation 10 of FIG. 1, the relay 170 of FIG. 6 connects the line and the modem 90 in operation 30 of FIG. 2. Here, a dial tone generated in the external exchange is input to the receiving terminal Rx of the modem 90 via a first path 150 after passing through the lines. In other words, the first path 150 corresponds to a path to input signals from the external line to the receiving terminal Rx of the modem 90, and a second path 152 corresponds to a path to transmit signals from the modem 90 to the external line via the transmission terminal Tx of the modem 90. In addition, in order to perform operation 52 of FIG. 3, the feedback path of FIG. 6, i.e., a third path 154, is formed. Here, the first through third paths 150, 152, and 154 can be formed by using an internal multiplexer (not shown) of the facsimile device or by controlling analog switches.

As described above, a self-diagnosis method for a facsimile device according to the present invention and a facsimile device to perform the same can self-diagnose errors in the peripheral environment of the facsimile device, i.e., errors on external lines, and errors in the facsimile device, e.g., errors in a modem, without using a separate external measuring instrument or without communicating with another device. Therefore, unnecessary calls are prevented and repair service can be promptly provided so that the cost for maintaining the facsimile device is reduced, and user satisfaction is increased.

Although a few preferred embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A self-diagnosis method for a facsimile device having a modem and a line interface unit (LIU) that connects the modem to an external line, the method comprising:
determining whether a communication path is in a normal state or in an abnormal state according to a detection of a dial tone transmitted from an outside; and
determining whether the modem is in a normal state or in an abnormal state according to whether a diagnosing tone signal generated in the facsimile device is normally received.

2. The method of claim 1, wherein the determining whether the communication path is in the normal state or in the abnormal state comprises:
preparing to detect the dial tone;
determining whether the dial tone is detected; and
determining the communication path to be in the abnormal state upon determining that the dial tone is not detected.

3. The method of claim 2, wherein the determining whether the communication path is in the normal state or in the abnormal state further comprises determining the communication path to be in the normal state upon determining that the dial tone is detected.

4. The method of claim 2, wherein the determining whether the communication path is in the normal state or in the abnormal state further comprises reporting the abnormal state of the communication path after determining the communication path to be in the abnormal state.

5. The method of claim 3, wherein the determining whether the communication path is in the normal state or in the abnormal state further comprises reporting the normal state of the communication path after determining the communication path to be in the normal state.

6. The method of claim 1, wherein the determining whether the modem is in the normal state or in the abnormal state comprises:
transmitting the diagnosing tone signal via a transmission terminal of the modem;
forming a feedback path to feed back the transmitted tone signal to a receiving terminal of the modem;
determining whether a frequency of the transmitted tone signal and a frequency of the tone signal which is received by the receiving terminal, are the same;
determining the modem to be in the abnormal state upon determining that the frequencies of the transmitted tone signal and the received tone signal are different; and
determining the modem to be in the normal state upon determining that the frequencies of the transmitted tone signal and the received tone signal are the same.

7. The method of claim 6, wherein the determining whether the modem is in the normal state or in the abnormal state further comprises:
determining whether a level of the received tone signal is greater than or equal to a predetermined level;
determining the modem to be in the abnormal state upon determining that the level of the received tone signal is less than the predetermined level; and
determining the modem to be in the normal state upon determining that the frequencies of the transmitted tone signal and the received tone signal are the same and the level of the received tone signal is greater than or equal to the predetermined level.

8. The method of claim 6, wherein the determining whether the modem is in the normal state or in the abnormal state further comprises reporting the abnormal state of the modem after the determining of the modem to be in the abnormal state upon determining that the frequencies of the transmitted tone signal and the received tone signal are different.

9. The method of claim 6, wherein the determining whether the modem is in the normal state or in the abnormal state further comprises reporting the normal state of the modem after the determining of the modem to be in the normal state upon determining that the frequencies of the transmitted tone signal and the received tone signal are the same.

10. The method of claim 7, wherein the modem further comprises a memory register to input data via the LIU to store the data and to output the stored data to the LIU, the method further comprising:
determining whether the memory register is in a normal state or in the abnormal state, wherein the determining the modem to be in the abnormal state comprises determining the modem to be in the abnormal state upon determining that the memory register is in the abnormal state, and the determining of the modem to be in the normal state comprises determining the modem to be in the normal state upon determining that the frequencies of the transmitted tone signal and the received tone signal are the same, the level of the received tone signal is greater than or equal to the predetermined level, and the memory register is in the normal state.

11. A facsimile device comprising:
a modem;
a line interface unit (LIU) including a communication path to connect the modem and an external line;
a dial tone detection unit to detect a dial tone and output a detection result; and
an error determination unit to determine whether the communication path is in a normal state or in an abnormal state in response to the detection result.

12. A facsimile device having an LIU to connect a modem and an external line, the facsimile device comprising:
a tone signal generation unit to generate and transmit a diagnosing tone signal;
a tone signal receiving unit to receive the transmitted tone signal; and
an error determination unit to determine whether the modem is in a normal state or in an abnormal state from the received tone signal and the transmitted tone signal.

13. The facsimile device of claim 11, further comprising an alarm unit to report the state of the communication path in response to the determination by the error determination unit.

14. The facsimile device of claim 12, further comprising an alarm unit to report the state of the modem in response to the determination by the error determination unit.

15. The facsimile device of claim 12, wherein the error determination unit comprises:
a first comparison unit to compare a frequency of the transmitted tone signal with a frequency of the received tone signal and to output a comparison result thereof as a first control signal; and
an error determiner to determine whether the modem is in the normal state or in the abnormal state in response to the first control signal.

16. The facsimile device of claim 15, wherein the error determination unit further comprises:
a second comparison unit to compare a level of the received tone signal with a predetermined level in response to the first control signal and to output a comparison result thereof as a second control signal,
wherein, the error determiner further determines whether the modem is in the normal state or in the abnormal state in response to the second control signal.

17. The facsimile device of claim 16, wherein the modem comprises a memory register to receive data via the LIU to store the data and to output the stored data to the LIU and the facsimile device further comprises:
a memory register examination unit to examine whether the memory register of the modem is in a normal state in response to the first control signal,
wherein the error determiner further determines whether the modem is in the normal state or in the abnormal state in response to a result of the examination performed by the memory register examination unit.

18. The facsimile device of claim 11, wherein the modem comprises the dial tone detection unit and the error determination unit.

19. The facsimile device of claim 12, wherein the modem comprises the tone signal generation unit, the tone signal receiving unit, and the error determination unit.

20. The method of claim 1, wherein the determining whether the modem is in the normal state further comprises:
determining whether a level of the received tone signal is greater than or equal to a predetermined level; and
determining the modem to be in the abnormal state upon determining that the level of the received tone signal is less than the predetermined level,
wherein, the determining of the modem to be in the normal state comprises determining the modem to be in the normal state upon determining that the level of the received tone signal is greater than or equal to the predetermined level.

21. The method of claim 1, wherein the modem comprises a memory register to input data via the LIU to store the data and to output the stored data to the LIU, and the method further comprises:
determining whether the memory register is in a normal state and determining the modem to be in the abnormal state upon determining that the memory register is in the abnormal state,
wherein, the determining of the modem to be in the normal state comprises determining the modem to be in the normal state upon determining that the memory register is in the normal state.
